(19) United States
(12) Patent Application Publication
(10) Pub. No.: US 2022/0126448 A1
(43) Pub. Date: Apr. 28, 2022

(54) Safety monitoring system and method for diagnosing abnormality of the same in a robot

(71) Applicant: TECHMAN ROBOT INC., Taoyuan City (TW)

(72) Inventors: Chun-Wen Lai, Taoyuan City (TW); I-Bing Su, Taoyuan City (TW)

(73) Assignee: TECHMAN ROBOT INC., Taoyuan City (TW)

(21) Appl. No.: 17/504,461

(22) Filed: Oct. 18, 2021

(30) Foreign Application Priority Data
Oct. 27, 2020 (TW) 109137547

(51) Int. Cl. B25J 9/16; B25J 19/06

(52) U.S. Cl. CPC B25J 9/1674; B25J 19/06

(57) ABSTRACT

A plurality of safety monitoring units are set on a plurality of loops of a safety monitoring system. A default test program is executed by each of the safety monitoring units. A length of test time of performing the default test program of each safety monitoring unit is compared with a length of verification time to diagnose any abnormality of the safety monitoring unit. When the safety monitoring unit is diagnosed as being abnormal, an abnormality notification is issued, a power switch is immediately turned off to stop the operations of the robot.

### CROSS REFERENCE TO RELATED APPLICATION

This application claims the benefit of Taiwan Application No. 109137547, filed on Oct. 27, 2020, the contents of which are incorporated herein in their entirety.

### BACKGROUND OF THE INVENTION

### 1. Field of the Invention

The present invention relates to a robot, in particular to a safety monitoring system in a robot and method for diagnosing abnormality of the safety monitoring system.

### 2. Description of the Prior Art

With the vigorous development of robot technology, factories use collaborative robots to assist operators in rapid processing, assembling and manufacturing operations. Although the production efficiency of the factories is improved, whether collaborative robots are operating normally has a serious impact on the safety of surrounding operators, so how to maintain the safety of robot operations has become an important safety standard specification in many countries.

The prior art U.S. Pat. No. 9,266,240 discloses that a first sensor is provided on a side of driving a motor of a robot to detect a rotation state of the motor, and a second sensor is provided on a driving output end of a speed reduction mechanism of the driving motor to detect the rotation state after deceleration. Then, the control system receives a first detection signal from the first sensor and a second detection signal from the second sensor, uses two loops to perform independent safety function calculations separately, and calculates the difference in comparison according to the first sensor signal and the second sensor signal to determine that the safety monitoring system is abnormal or malfunctioning. After determining that the safety monitoring system is abnormal, the robot's safety function, which is calculated according to the first detection signal of the first sensor or the second detection signal of the second sensor, also loses its accuracy and cannot maintain reliable safety monitoring of the robot. Therefore, it is necessary to immediately start the safety setting and stop the robot in an emergency to avoid collision damage by the robot and keep surrounding workers safe.

However, the aforementioned prior art immediately activates the safety setting after determining that the safety monitoring system is abnormal, which will cause the robot to stop. This not only affects the production efficiency of the factory, but cannot determine which set of sensors or which loop of the safety monitoring system is abnormal, so it will take time to find out the failed components for repair after shutdown. Accordingly, the maintenance cost is increased, the standby time is extended, and the production efficiency of the factory is reduced. Therefore, there are still problems that need to be solved urgently in the method of diagnosing a safety monitoring system for robots.

### SUMMARY OF THE INVENTION

It is an object of the present invention to provide a safety monitoring system and a method for diagnosing abnormality of the safety monitoring system in a robot. By using a plurality of safety monitoring units set on a plurality of loops, a default test program is executed regularly by the individual safety monitoring units, and a length of a test time of performing the default test program of each safety monitoring unit is compared with a length of a verification time to diagnose every safety monitoring unit of the robot so as to improve the efficiency of maintenance.

It is another object of the present invention to provide a safety monitoring system and a method for diagnosing abnormality of the safety monitoring system in a robot. When the safety monitoring system is diagnosed as being abnormal, a power switch is immediately turned off and the robot is stopped to improve safety.

It is another object of the present invention to provide a safety monitoring system and a method for diagnosing abnormality of the safety monitoring system in a robot. When the safety monitoring system is diagnosed as being abnormal, an abnormality notification is issued, and a normal safety monitoring unit is selected for operation and waiting for maintenance to improve production efficient.

In order to achieve the aforementioned objects of the present invention, the safety monitoring system generates operating signals via a robot, and stores a default test program and a verification time of performing the default test program before the robot leaves a factory which manufactures the robot. A plurality of safety monitoring units receive the operating signals from the robot and performing safety function calculations for a plurality of loops to monitor operations of the robot. A power supply supplies electric power to the robot and the plurality of safety monitoring units. A plurality of power switches corresponding to the plurality of safety monitoring units are set on paths for delivering electric power from the power supply to the robot. The safety monitoring system compares a length of a test time of performing the default test program of each safety monitoring unit with the length of the verification time stored by the safety monitoring system. When an absolute value of difference between the length of the test time and the length of the verification time is not greater than a predetermined threshold, the safety monitoring unit is diagnosed to be normal, and a power switch corresponding to the normal safety monitoring unit is turned on to supply electric power to the robot. When the absolute value of difference between the length of the test time and the length of the verification time is greater than the predetermined threshold, the safety monitoring unit is diagnosed to be abnormal, and the power switch corresponding to the abnormal safety monitoring unit is turned off to stop supplying electric power to the robot.

According to a method for diagnosing a safety monitoring system of a robot of the present invention, a default test program and a verification time is stored firstly. Then, a diagnose procedure is performed automatically and regularly. A plurality of safety monitoring units perform the default test program and record a length of a test time of performing the default test program. An absolute value of difference between the length of the test time and the length of the verification time is calculated. When the absolute value of difference between the length of the test time and the length of the verification time is not less than the predetermined threshold, the safety monitoring unit is diagnosed to be abnormal, and the power switch corresponding to the abnormal safety monitoring unit is turned off to stop supplying electric power to the robot. When the absolute value of difference between the length of the test time and the length of the verification time is less than the predetermined threshold, the safety monitoring unit is diagnosed to be normal, and a power switch corresponding to the normal safety monitoring unit is turned on to drive the robot normally.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a safety monitoring system of the present invention.

FIG. 2 is a flowchart of a method for diagnosing abnormalities of the safety monitoring system of the robot according to the present invention.

FIG. 3 is a flowchart of a method for diagnosing abnormalities of the safety monitoring system of the robot according to another embodiment of the present invention.

### DETAILED DESCRIPTION

The present disclosure may be understood by reference to the following detailed description, taken in conjunction with the drawings as described below, and for purposes of illustrative clarity and being easily understood by the readers, various drawings of this disclosure may be simplified, and the elements in various drawings may not be drawn to scale. In addition, the number and dimension of each element shown in drawings are only illustrative and are not intended to limit the scope of the present disclosure.

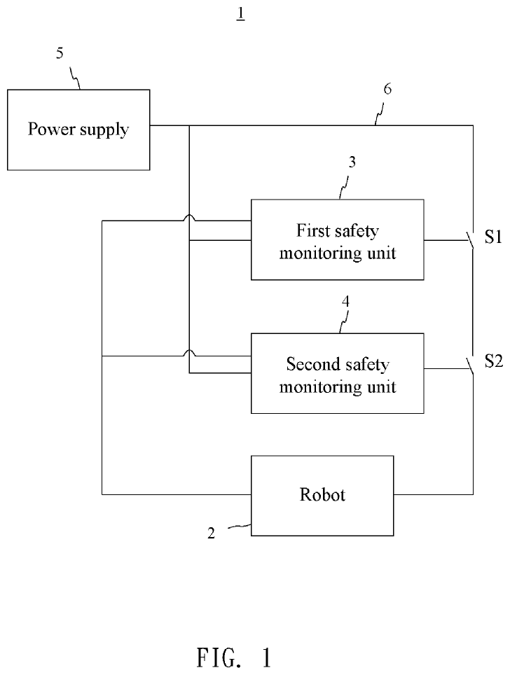

Please refer to FIG. 1. FIG. 1 is a functional block diagram of a safety monitoring system 1 of the present invention. In FIG. 1, the safety monitoring system 1 of the present invention is equipped with a first safety monitoring unit 3 and a second safety monitoring unit 4 for a robot 2 to monitor whether safety functions of the robot 2 are operating normally by two separate loops. The safety monitoring unit 3 and the second safety monitoring unit 4 are illustrated as examples, but the present invention is not limited to this, and the present invention can also be applied to more safety monitoring units. The safety monitoring system 1 of the present invention further comprises a power supply 5, which respectively supplies electric power to the robot 2, the first safety monitoring unit 3, and the second safety monitoring unit 4. The safety monitoring system 1 further comprises a first power switch S1 and a second power switch S2, which are set on the paths for delivering electric power from the power supply 5 to the robot 2. The safety monitoring system 1 turns on or turns off the first power switch S1 to control the supply of electric power to the robot 2 according to whether the first safety monitoring unit 3 is detected to be abnormal, and the safety monitoring system 1 turns on or turns off the second power switch S2 to control the supply of electric power to the robot 2 according to whether the second safety monitoring unit 4 is detected to be abnormal. When the power delivered via the path 6 is delivered to the robot 2, the robot 2 would operate normally. When the power delivered via the path 6 is interrupted, the robot 2 stops operating immediately.

The first safety monitoring unit 3 and the second safety monitoring unit 4 of the safety monitoring system 1 of the present invention are connected to the robot 2, and separately receive the operation signals of the robot 2 and execute a default test program to calculate various safety functions of the robot 2 to monitor the operations of the robot 2. Each safety monitoring unit on a normal loop of the safety monitoring system 1 would execute the default test program to perform a specific calculation procedure of a safety function for a certain length of processing time. Once an abnormality occurs in the loop of the safety monitoring unit (for example, a microprocessor, a sensor, or an electronic component of the loop operates abnormally), the safety monitoring unit would not operate normally, resulting in a delay in the processing time and increasing the processing time. Therefore, whether the processing time of the safety monitoring unit for performing the specific calculation procedure of the safety function increases can be used as a standard for diagnosing whether the safety monitoring system is abnormal.

Before the robot 2 leaves the factory which manufactures the robot 2, and when the robot 2 is diagnosed as being normal, by executing the default test program to perform the specific calculation procedure of the safety function, each safety monitoring unit calculates the specific safety function, and a length of a test time of performing the default test program of each safety monitoring unit is recorded and used as a length of a verification time (Tr) of each safety monitoring unit. The default test program and the length of the verification time (Tr) of each safety monitoring unit are stored in the robot 2 for reference. After the robot 2 leaves the factory, while the robot 2 is running, the safety monitoring system 1 of the present invention will set each safety monitoring unit of the robot 2 to automatically and regularly execute the stored default test program (of a diagnose procedure), and to record a length of a test time (Td) of performing the default test program. The test time (Td) of each safety monitoring unit would be compared with the verification time (Tr), and an absolute value of difference between the length of the test time (Td) of each safety monitoring unit and the length of the verification time (Tr) would be calculated. If the absolute value of the difference is less than the predetermined threshold, it means that the safety monitoring unit operates normally, and the test time for executing the default test program has not increased, and the safety monitoring system 1 will keep turning on the corresponding power switch of the safety monitoring unit to keep the robot 2 operate normally. If the absolute value of the difference is equal to or greater than the predetermined threshold, it means that the safety monitoring unit in operation is abnormal, the test time for executing the default test program has increased, the safety monitoring system 1 will issue a notification to indicate that the safety monitoring unit is abnormal, and the power switch corresponding to the safety monitoring unit is controlled to be turned off, so that the robot 2 would stop operating. Therefore, the safety monitoring system 1 of the present invention will turn off the power switch corresponding to the safety monitoring unit to stop the operations of the robot 2 to ensure safety.

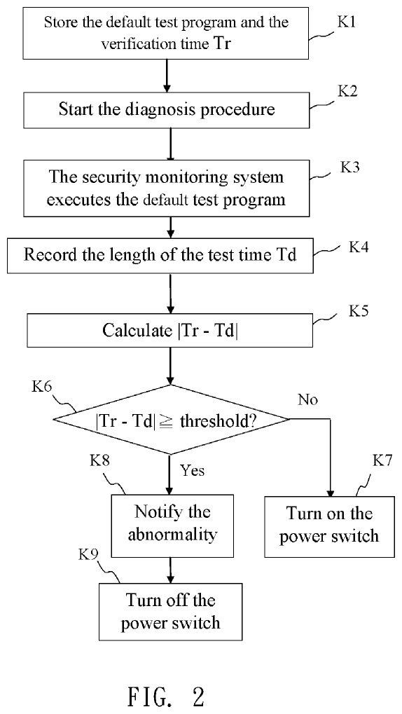

Please refer to FIG. 2. FIG. 2 is a flowchart of a method for diagnosing abnormalities of the safety monitoring system 1 of the robot 2 according to the present invention. The detailed steps of the method are described as follows. In step K1, the default test program and the verification time (Tr) are stored. In step K2, the diagnosis procedure is started automatically and regularly. In step K3, each safety monitoring unit executes the default test program. In step K4, the test time (Td) is recorded. In step K5, the absolute value of difference between the length of the test time (Td) and the verification time (Tr) is calculated. Step K6 determines whether the absolute value of the difference is less than the predetermined threshold. If the absolute value of the difference is less than the predetermined threshold, it means that the safety monitoring system 1 is normal and that the power switch corresponding to the safety monitoring unit would stay turned on to keep the robot 2 operate normally, and then step K7 would be executed. If the absolute value of the difference is equal to or greater than the predetermined threshold, it means that the safety monitoring system 1 is abnormal, and then step K8 would be executed. In step K8, the abnormality of the certain safety monitoring unit is notified. In step K9, the power switch corresponding to the safety monitoring unit is turned off to stop the operations of the robot 2.

Therefore, the safety monitoring system and the method for diagnosing abnormalities of the safety monitoring system 1 of the robot 2 in the present invention use the safety monitoring units on a plurality of loops to automatically and regularly execute the default test program and compare the test time and the verification time. Any abnormality of the safety monitoring units would be identified and reported. The power switch corresponding to the safety monitoring unit which detects its abnormality would be turned off immediately to stop the robot 2, so as to improve the efficiency of maintenance and the safety of operating. The safety monitoring system 1 may execute the default test program automatically at a fixed time.

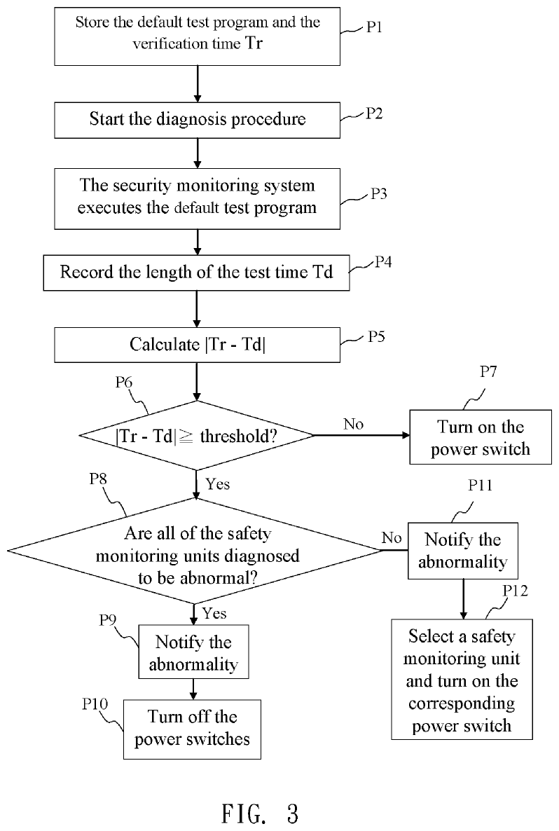

Please refer to FIG. 3. FIG. 3 is a flowchart of a method for diagnosing abnormalities of the safety monitoring system 1 of the robot 2 using the safety monitoring system 1 according to another embodiment of the present invention. Steps P1 to P7 in the embodiment are the same as steps K1 to K7 in the previous embodiment. The main difference is that in this embodiment, after an abnormal safety monitoring unit is diagnosed, a normal safety monitoring unit is selected to allow the safety monitoring system of the robot to maintain normal operations, so as to improve production efficiency. The detailed steps of the method for diagnosing abnormality of safety monitoring system of the robot in the embodiment are described as follows. In step P1, the default test program and the verification time (Tr) are stored. In step P2, the diagnosis procedure is started automatically and regularly. In step P3, each safety monitoring unit executes the default test program. In step P4, the test time (Td) is recorded. In step P5, the absolute value of difference between the length of the test time (Td) and the verification time (Tr) is calculated. Step P6 determines whether the absolute value of the difference is less the predetermined threshold. If the absolute value of the difference is less than the predetermined threshold, it means that the safety monitoring system 1 is normal and that the power switch corresponding to the safety monitoring unit would stay turned on (step P7) to keep the robot 2 operate normally.

In step P6, if the absolute value of the difference is equal to or greater than the predetermined threshold, it means that the safety monitoring system 1 is abnormal and the power switch corresponding to the safety monitoring unit would be turned off to stop the operations of the robot 2, and then step P8 would be executed. Step P8 determines whether all of safety monitoring units are diagnosed to be abnormal. If so, step P9 is executed to notify that all of safety monitoring units are diagnosed to be abnormal. Then, step P10 is executed to turn off all of the power switches to stop the operations of the robot 2. In step P8, if all of safety monitoring units are not diagnosed to be abnormal, step P11 would be executed to indicate that there at least one of safety monitoring units is diagnosed to be abnormal. Then step P12 is executed to select a safety monitoring unit which is normal and turn on the corresponding power switch to maintain the operations of the robot 2.

According to the present invention, the safety monitoring system would send an abnormal notification when detecting the abnormality of the safety monitoring system. While waiting for maintenance, the power switch corresponding to a safety monitoring unit which is normal would be turned on to maintain the operations of the robot. Therefore, efficiency of production would be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A safety monitoring system, comprising:
a robot, generating operating signals, and storing a default test program and a verification time;
a plurality of safety monitoring units, receiving the operating signals from the robot and performing safety function calculations via a plurality of loops to monitor operations of the robot;
a power supply, supplying electric power to the robot and the safety monitoring units; and
a plurality of power switches, corresponding to the safety monitoring units and set on paths for delivering electric power from the power supply to the robot;
wherein a length of a test time of performing the default test program of each safety monitoring unit is compared with a length of the verification time;
wherein when an absolute value of difference between the length of the test time and the length of the verification time is less than a predetermined threshold, one of the safety monitoring units is diagnosed to be normal, and a power switch corresponding to the normal safety monitoring unit is turned on; and
wherein when the absolute value of difference between the length of the test time and the length of the verification time is equal to or greater than the predetermined threshold, at least one of the safety monitoring units is diagnosed to be abnormal, and the power switch corresponding to the abnormal safety monitoring unit is turned off.

2. The safety monitoring system of claim 1, wherein when one of power switches is turned on, electric power is supplied to the robot and the robot starts to operate; and
wherein when one of the power switches is turned off, electric power to the robot is terminated and the robot stops operating.

3. The safety monitoring system of claim 1, wherein the verification time is a time the robot executing the default test program before the robot leaves a factory which manufactures the robot.

4. The safety monitoring system of claim 1, wherein the default test program is a preset program for a specific calculation procedure of a safety function.

5. A method for diagnosing a safety monitoring system of a robot, the method comprising:
storing a default test program and a verification time;
beginning a diagnose procedure;
a plurality of safety monitoring units performing the default test program;
recording a length of a test time of performing the default test program by each safety monitoring unit;
calculating an absolute value of difference between the length of the test time and the length of the verification time;
determining that the absolute value is equal to or greater than a predetermined threshold; and
diagnosing at least one of the safety monitoring units as being abnormal.

6. The method of claim 5, wherein when the absolute value is less than the predetermined threshold, the at least one of safety monitoring units is diagnosed as being normal, and a power switch corresponding to the normal safety monitoring unit is kept turning on to allow the robot to operate normally.

7. The method of claim 5, further comprising:
when the at least one of safety monitoring units is diagnosed as being abnormal, the safety monitoring system notifying that the at least one of safety monitoring units is abnormal, and turning off a power switch corresponding to the abnormal safety monitoring unit to turn off the robot.

8. The method of claim 5, further comprising:
after the at least one of safety monitoring units is diagnosed as being abnormal, all other safety monitoring units are diagnosed again; and
when all of the plurality of safety monitoring units are diagnosed as being abnormal, the safety monitoring system notifying the abnormality, and turning off power switches to turn off the robot.

9. The method of claim 8, wherein if all of the plurality of safety monitoring units are not diagnosed as being abnormal, the safety monitoring system reports the abnormality of at least one of safety monitoring units.

10. The method of claim 9, wherein if all of the plurality of safety monitoring units are not diagnosed as being abnormal, one of the plurality of safety monitoring units is selected and controls the corresponding power switch to keep turning on to maintain normal operations of the robot.

11. The method of claim 5, wherein the safety monitoring system executes the default test program automatically at a fixed time.
